(19) United States
(12) Patent Application Publication
(10) Pub. No.: US 2021/0209467 A1
(43) Pub. Date: Jul. 8, 2021

(54) METHOD AND DEVICE FOR PREDICTING THERMAL LOAD OF ELECTRICAL SYSTEM

(71) Applicant: ENNEW DIGITAL TECHNOLOGY CO., LTD., Langfang (CN)

(72) Inventors: Xin HUANG, Langfang (CN); Shengwei LIU, Langfang (CN)

(73) Assignee: ENNEW DIGITAL TECHNOLOGY CO., LTD., Langfang (CN)

(21) Appl. No.: 17/058,664

(22) PCT Filed: Sep. 25, 2019
(86) PCT No.: PCT/CN2019/107946

§ 371 Date: Nov. 25, 2020

(30) Foreign Application Priority Data
Sep. 25, 2018 (CN) 201811114080.8

(51) Int. Cl. G06N 3/08; G06Q 10/04

(52) U.S. Cl. CPC G06N 3/08; G06N 20/00; G06Q 10/04

(57) ABSTRACT

A method and device for predicting a thermal load of an electrical system are provided. The method includes: S1: pre-processing historical daily data of the thermal load of an electrical system. S2: acquiring a data daily reference line according to pre-processed historical daily data. S3: dividing acquired data daily reference line into a plurality of time sections. S4: screening the historical daily data, and calculating a trend similarity value of screened historical daily data and the data daily reference line within each divided time section of the plurality of time sections respectively. S5: choosing the historical daily data corresponding to the trend similarity value greater than a preset reference value to form a similarity sequence matrix. S6: inputting the similarity sequence matrix into an extreme learning machine (ELM) for training, acquiring a prediction model, and predicting the thermal load of the electrical system.

### CROSS REFERENCE TO THE RELATED APPLICATIONS

This application is the national stage entry of International Application No. PCT/CN2019/107946, filed on Sep. 25, 2019, which is based upon and claims priority to Chinese Patent Application No. 201811114080.8, filed on Sep. 25, 2018, the entire contents of which are incorporated herein by reference.

### TECHNICAL FIELD

The present disclosure relates to the field of data analysis technologies, and in particular, to a method and device for predicting thermal load of an electrical system.

### BACKGROUND

Time sequences widely exist in people's daily life and industrial production, such as real-time trading data of funds or stocks, daily sales data of retail markets, sensor monitoring data of process industries, astronomical observation data, aerospace radar, satellite monitoring data, real-time weather temperatures, and air quality indexes. So far, many time-sequence analysis methods have been proposed in the industry, including a similarity query method, a classification method, a clustering method, a prediction method, an anomaly detection method, and the like. Many methods need to judge the similarity of time sequences. Therefore, a time-sequence similarity measurement method has a wide range of application requirements in the industry.

However, existing electrical system thermal load predictions are all algorithms that select a similar trend based on a single weather factor, which does not take into account factors affecting load changes in different time sections of the same load day. Thus, the accuracy of the thermal load predictions is affected.

### SUMMARY

Embodiments of the present disclosure provide a method and device for predicting thermal load of an electrical system, which predict, based on dynamic segmentation and an extreme learning machine (ELM) algorithm, a load trend in the next 24 hours, improving the accuracy of prediction.

In a first aspect, an embodiment of the present disclosure provides a method for predicting the thermal load of an electrical system, the method including:

S1: pre-processing historical daily data of the thermal load of an electrical system;

S2: acquiring a data daily reference line according to the pre-processed historical daily data;

S3: dividing the acquired data daily reference line into multiple time sections;

S4: screening the historical daily data, and calculating a trend similarity value of the screened historical daily data and the data daily reference line within each divided time section respectively;

S5: choosing historical daily data corresponding to a trend similarity value greater than a preset reference value to form a similarity sequence matrix; and

S6: inputting the similarity sequence matrix into a constructed ELM for training, acquiring a prediction model, and predicting the thermal load of the electrical system.

Preferably, a specific process of step S1 includes:

denoising, filling, and normalizing the historical daily data of the thermal load of the electrical system.

Preferably, a specific process of step S2 includes:

taking a data mean of a preset number of days closest to a to-be-predicted day as the data daily reference line.

Preferably, a specific process of step S3 includes:

dividing the data daily reference line into multiple time sections according to extreme points in the data daily reference line.

Preferably, a specific process of step S3 includes:

dividing the data daily reference line into multiple time sections according to according to points with a difference between slopes of two adjacent points greater than a preset threshold and extreme points in the data daily reference line.

Preferably, a specific process of step S4 includes:

calculating similarity values of historical days and a to-be-predicted day, and selecting similar historical days corresponding to similarity values greater than a preset threshold; and

calculating a trend similarity value of similar historical daily data and the data daily reference line within each divided time section respectively.

In a second aspect, an embodiment of the present disclosure provides a device for predicting the thermal load of an electrical system, the device including: a data processing module, a baseline determination module, a time segmentation module, a similarity calculation module, a sample screening module, and a training model module, wherein

the data processing module is configured to pre-process historical daily data of the thermal load of an electrical system;

the baseline determination module is configured to acquire a data daily reference line according to the pre-processed historical daily data;

the time segmentation module is configured to divide the acquired data daily reference line into multiple time sections;

the similarity calculation module is configured to screen the historical daily data, and calculate a trend similarity value of the screened historical daily data and the data daily reference line within each divided time section respectively;

the sample screening module is configured to choose historical daily data corresponding to a trend similarity value greater than a preset reference value to form a similarity sequence matrix; and

the training model module is configured to input the similarity sequence matrix into a constructed ELM for training, acquire a prediction model, and predict the thermal load of the electrical system.

Preferably, the data processing module is particularly configured to denoise, fill, and normalize the historical daily data of the thermal load of the electrical system.

Preferably, the baseline determination module is particularly configured to take a data mean of a preset number of days closest to a to-be-predicted day as the data daily reference line.

Preferably, the time segmentation module is particularly configured to divide the data daily reference line into multiple time sections according to extreme points in the data daily reference line.

Preferably, the time segmentation module is particularly configured to divide the data daily reference line into multiple time sections according to according to points with a difference between slopes of two adjacent points greater than a preset threshold and extreme points in the data daily reference line.

Preferably, the similarity calculation module is particularly configured to calculate similarity values of historical days and a to-be-predicted day, select similar historical days corresponding to similarity values greater than a preset threshold, and calculate a trend similarity value of similar historical daily data and the data daily reference line within each divided time section respectively.

Compared with the prior art, the present disclosure has at least the following beneficial effects:

1. The present disclosure has intelligent learning capability, and can improve the accuracy of prediction.

2. The present disclosure effectively retains important change trend information in a time sequence of a thermal load by using a time sequence representation method based on trend segmentation, thereby being capable of more accurately predicting the change trend of the thermal load.

### BRIEF DESCRIPTION OF THE DRAWINGS

In order to more clearly illustrate technical solutions in the embodiments of the present disclosure or in the prior art, the accompanying drawings used in the embodiments or the prior art are briefly introduced as follows. Apparently, the drawings described as follows are merely part of the embodiments of the present disclosure, other drawings can also be acquired by those of ordinary skilled in the art according to the drawings without paying creative efforts.

FIG. 1 is a flowchart of a method for predicting the thermal load of an electrical system according to an embodiment of the present disclosure; and

FIG. 2 is a block diagram of a device for predicting the thermal load of an electrical system according to an embodiment of the present disclosure.

### DETAILED DESCRIPTION OF THE EMBODIMENTS

To make the objectives, technical solutions, and advantages of the embodiments of the present disclosure much clearer, the technical solutions in the embodiments of the present disclosure are described clearly and completely below with reference to drawings in the embodiments of the present disclosure. It is obvious that the embodiments to be described are only a part rather than all of the embodiments of the present disclosure. All other embodiments derived by those of ordinary skill in the art based on the embodiments of the present disclosure without paying creative efforts should fall within the protection scope of the present disclosure.

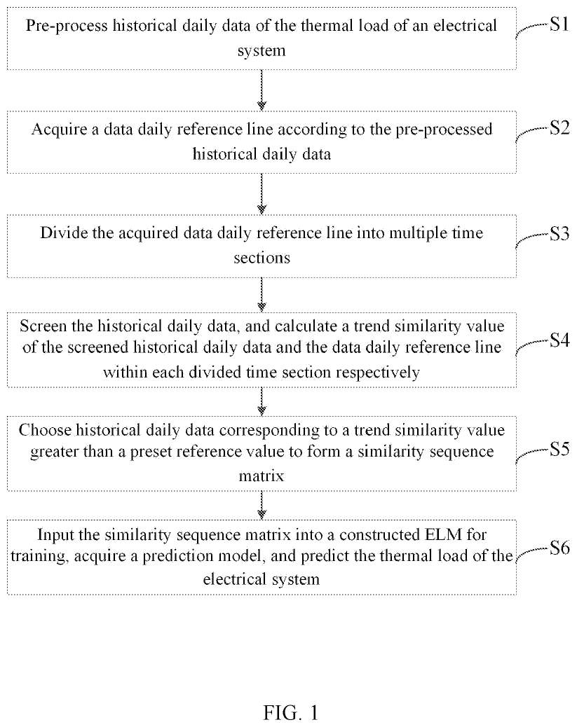

As shown in FIG. 1, an embodiment of the present disclosure provides a method for predicting the thermal load of an electrical system. The method may include the following steps:

S1: Pre-process historical daily data of the thermal load of an electrical system.

S2: Acquire a data daily reference line according to the pre-processed historical daily data.

S3: Divide the acquired data daily reference line into multiple time sections.

S4: Screen the historical daily data, and calculate a trend similarity value of the screened historical daily data and the data daily reference line within each divided time section respectively.

S5: Choose historical daily data corresponding to a trend similarity value greater than a preset reference value to form a similarity sequence matrix.

S6: Input the similarity sequence matrix into a constructed ELM for training, acquire a prediction model, and predict the thermal load of the electrical system.

In the embodiment, an ELM neural network is constructed. The network is divided into three layers: an input layer, a hidden layer, and an output layer. A learning process thereof does not need to adjust node parameters of the hidden layer, and feature mapping from the input layer to the hidden layer may be random or artificially given. The learning process thereof is easy to converge at a global minimum. For given N sets of training data, using an ELM to learn L hidden layers and M output layers includes the following steps: (1) Randomly assign node parameters: at the beginning of calculation, node parameters of SLFN may be randomly generated, that is, node parameters are independent from input data. Random generation here may follow any continuous probability distribution. (2) Calculate an output matrix of the hidden layer: a size of the output matrix of the hidden layer is N rows and M columns, that is, the number of rows is the number of input training data, and the number of columns is the number of nodes in the hidden layer. The output matrix is essentially a result of mapping N input data to L nodes. (3) Solve an output weight: a size of an output weight matrix of the hidden layer is L rows and M columns, that is, the number of rows is the number of nodes in the hidden layer, and the number of columns is the number of nodes in the output layer. Different from other algorithms, in an ELM algorithm, the output layer may (or is suggested to) have no error nodes. Therefore, when there is only one output variable, the output weight matrix is a vector. The core of the ELM algorithm is to solve an output weight to minimize an error function.

In this embodiment, the method has intelligent learning capability, and can improve the accuracy of prediction. The method effectively retains important change trend information in a time sequence of a thermal load by using a time sequence representation method based on trend segmentation, thereby being capable of more accurately predicting the change trend of the thermal load.

It is worth noting that all embodiments in this application are based on a particular assumption. The assumption includes assuming that historical real-time meteorological factors are known, such as hourly temperature and humidity; and assuming that to-be-predicted 24-hour meteorological factors are known (available from a weather platform).

In an embodiment of the present disclosure, a specific process of step S1 includes:

denoising, filling, and normalizing the historical daily data of the thermal load of the electrical system.

In this embodiment, preprocessing of historical daily data can improve the data accuracy and further ensure the accuracy of thermal load prediction.

In an embodiment of the present disclosure, a specific process of step S2 includes:

taking a data mean of a preset number of days closest to a to-be-predicted day as the data daily reference line.

In this embodiment, for time sequence data, relatively important influence points are generally local maximum and minimum points, while for short-term loads, a time point closer to a to-be-predicted day has a greater impact on the prediction, which is commonly known as the principle of “near big, far small.” In this application, a data mean of a preset number of days closest to a to-be-predicted day is selected as the data daily reference line. For example, if the preset number of days is three, there may be three pieces of historical data at the same moment. If a mean value is calculated for the same moment, a reference value of the moment may be obtained. If all the moments are calculated, a data daily reference line of the data may be obtained. In addition, through data corresponding to N days with meteorological trend similarities between the to-be-predicted day and the historical days ranking ahead, a mean value thereof can also be obtained as the data daily reference line. The particular value of N may be determined according to an actual situation. For example, historical data of 10 days is now available, meteorological trend similarities between the 10 days and a to-be-predicted day are A, B, C, D, E, F, G, H, I, M, and P respectively, and A>B>C>D>E>F>G>H>I>M>P. If N is 3, selected data is data corresponding to A, B, and C.

In an embodiment of the present disclosure, a specific process of step S3 includes:

dividing the data daily reference line into multiple time sections according to extreme points in the data daily reference line.

In the embodiment, the data daily reference line is divided into multiple time sections through maximum and minimum values. For example, in a 24-hour period, there are two maximum values and two minimum values, and there are four key points, so the data daily reference line is divided into five sections.

In an embodiment of the present disclosure, a specific process of step S3 includes:

dividing the data daily reference line into multiple time sections according to according to points with a difference between slopes of two adjacent points greater than a preset threshold and extreme points in the data daily reference line.

In the embodiment, key points of the divided time sections are determined through maximum and minimum values, and the key points are corrected according to actual data. In addition, the key points may also be corrected according to professional knowledge. For example, a small peak of growth may occur between 16:00 and 18:00 in a service, and then the two points 16:00 and 18:00 may be taken as key points during segmentation.

In an embodiment of the present disclosure, a specific process of step S4 includes:

calculating similarity values of historical days and a to-be-predicted day, and selecting similar historical days corresponding to similarity values greater than a preset threshold; and

calculating a trend similarity value of similar historical daily data and the data daily reference line within each divided time section respectively.

In the embodiment, the trend similarity value may be calculated through the following formulas:

$${R}_{X Y} = \frac{2 [ E ( X Y ) - E ( X ) E ( Y ) ]}{D ( X ) + D ( Y )} , X = ( {x}_{1} , {x}_{2} , … , {x}_{n} ) , Y = ( {y}_{1} , {y}_{2} , … , {y}_{n} )$$

where, R_{XY} represents the trend similarity value, E(XY) represents an expectation of XY, E(X) represents an expectation of X, E(Y) represents an expectation of Y, D(X) represents variance of X, and D(Y) represents variance of Y. X is the data daily reference line, and Y is the historical daily data.

In the embodiment, historical daily data corresponding to a trend similarity value greater than a preset reference value is chosen to form a similarity sequence matrix. The matrix may be:

$${c}_{i j} = [ \begin{matrix}{c}_{11} & {c}_{12} & … & {c}_{1 j} \\ {c}_{21} & {c}_{22} & … & {c}_{2 j} \\ ⋮ & ⋮ & ⋮ & ⋮ \\ {c}_{i 1} & {c}_{i 2} & … & {c}_{i j}\end{matrix} ]$$

where, cᵢⱼ is the j^{th} similarity sequence of the i^{th} section in the divided time sections.

Here, the superiority of the present disclosure is verified by experiment. Thermal load predicted values of 30 days (24 hours a day, corresponding to a thermal load value per hour, and the time section is selected as 2018.06.01-2018.06.30) are selected as experimental data, in which data of 23 days is used as training set data, and data of the last 7 days is used as a test data set. A root mean square error (RMSE) and a mean absolute percentage error (MAPE) are selected as measurement indexes of experimental results.

Three algorithms are compared respectively:

(1) a simple weather similarity algorithm;

(2) a similar subsequence direct connection algorithm; and

(3) the algorithm of the present disclosure.

Description is provided by comparing RMSE and MAPE indexes of the three methods, and data is as follows:

$$RMSE \text{:} RMSE = \sqrt{\frac{1}{n} {\sum }_{i = 1}^{n} {( {y}_{d} ( i ) - {y}_{t} ( i ) )}^{2}}$$

$$MAPE \text{:} MAPE = \frac{1}{n} {\sum }_{i = 1}^{n} \vert ( {y}_{d} ( i ) - {y}_{t} ( i ) ) \text{/} {y}_{t} ( i ) \vert \times 100 \%$$

where: yₜ represents a true value, y_{d} represents a predicted value, and n represents a sample number.

Calculation results are as shown in Table 1 below:

TABLE 1

| | | | Similar |
|---|---|---|---|
| | | Simple | subsequence |
| | Algorithm as | weather | direct |
| Evaluation | provided | similarity | connection |
| index | herein | algorithm | algorithm |
| RMSE | 1.19 | 2.38 | 1.85 |
| MAPE | 3.38% | 6.11% | 4.52% |

Through the comparison of experimental data, it can be seen that the method proposed herein can achieve better effects in thermal load prediction.

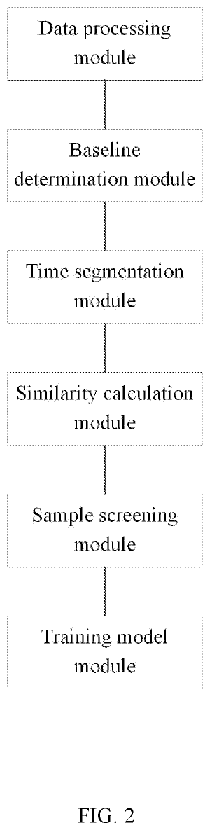

As shown in FIG. 2, an embodiment of the present disclosure provides a device for predicting the thermal load of an electrical system, the device including: a data processing module, a baseline determination module, a time segmentation module, a similarity calculation module, a sample screening module, and a training model module, wherein

the data processing module is configured to pre-process historical daily data of the thermal load of an electrical system;

the baseline determination module is configured to acquire a data daily reference line according to the pre-processed historical daily data;

the time segmentation module is configured to divide the acquired data daily reference line into multiple time sections;

the similarity calculation module is configured to screen the historical daily data, and calculate a trend similarity value of the screened historical daily data and the data daily reference line within each divided time section respectively;

the sample screening module is configured to choose historical daily data corresponding to a trend similarity value greater than a preset reference value to form a similarity sequence matrix; and

the training model module is configured to input the similarity sequence matrix into a constructed ELM for training, acquire a prediction model, and predict the thermal load of the electrical system.

In the embodiment, an ELM neural network is constructed. The network is divided into three layers: an input layer, a hidden layer, and an output layer. A learning process thereof does not need to adjust node parameters of the hidden layer, and feature mapping from the input layer to the hidden layer may be random or artificially given. The learning process thereof is easy to converge at a global minimum. For given N sets of training data, using an ELM to learn L hidden layers and M output layers includes the following steps: (1) Randomly assign node parameters: at the beginning of calculation, node parameters of SLFN may be randomly generated, that is, node parameters are independent from input data. Random generation here may follow any continuous probability distribution. (2) Calculate an output matrix of the hidden layer: a size of the output matrix of the hidden layer is N rows and M columns, that is, the number of rows is the number of input training data, and the number of columns is the number of nodes in the hidden layer. The output matrix is essentially a result of mapping N input data to L nodes. (3) Solve an output weight: a size of an output weight matrix of the hidden layer is L rows and M columns, that is, the number of rows is the number of nodes in the hidden layer, and the number of columns is the number of nodes in the output layer. Different from other algorithms, in an ELM algorithm, the output layer may (or is suggested to) have no error nodes. Therefore, when there is only one output variable, the output weight matrix is a vector. The core of the ELM algorithm is to solve an output weight to minimize an error function.

In this embodiment, the device has intelligent learning capability, and can improve the accuracy of prediction. The device effectively retains important change trend information in a time sequence of a thermal load by using a time sequence representation method based on trend segmentation, thereby being capable of more accurately predicting the change trend of the thermal load.

It is worth noting that all embodiments in this application are based on a particular assumption. The assumption includes assuming that historical real-time meteorological factors are known, such as hourly temperature and humidity; and assuming that to-be-predicted 24-hour meteorological factors are known (available from a weather platform).

In an embodiment of the present disclosure, the data processing module is particularly configured to denoise, fill, and normalize the historical daily data of the thermal load of the electrical system.

In this embodiment, preprocessing of historical daily data can improve the data accuracy and further ensure the accuracy of thermal load prediction.

In an embodiment of the present disclosure, the baseline determination module is particularly configured to take a data mean of a preset number of days closest to a to-be-predicted day as the data daily reference line.

In this embodiment, for time sequence data, relatively important influence points are generally local maximum and minimum points, while for short-term loads, a time point closer to a to-be-predicted day has a greater impact on the prediction, which is commonly known as the principle of “near big, far small.” In this application, a data mean of a preset number of days closest to a to-be-predicted day is selected as the data daily reference line. For example, if the preset number of days is three, there may be three pieces of historical data at the same moment. If a mean value is calculated for the same moment, a reference value of the moment may be obtained. If all the moments are calculated, a data daily reference line of the data may be obtained. In addition, through data corresponding to N days with meteorological trend similarities between the to-be-predicted day and the historical days ranking ahead, a mean value thereof can also be obtained as the data daily reference line. The particular value of N may be determined according to an actual situation. For example, historical data of 10 days is now available, meteorological trend similarities between the 10 days and a to-be-predicted day are A, B, C, D, E, F, G, H, I, M, and P respectively, and A>B>C>D>E>F>G>H>I>M>P. If N is 3, selected data is data corresponding to A, B, and C.

In an embodiment of the present disclosure, the time segmentation module is particularly configured to divide the data daily reference line into multiple time sections according to extreme points in the data daily reference line.

In the embodiment, the data daily reference line is divided into multiple time sections through maximum and minimum values. For example, in a 24-hour period, there are two maximum values and two minimum values, and there are four key points, so the data daily reference line is divided into five sections.

In an embodiment of the present disclosure, the time segmentation module is particularly configured to divide the data daily reference line into multiple time sections according to according to points with a difference between slopes of two adjacent points greater than a preset threshold and extreme points in the data daily reference line.

In the embodiment, key points of the divided time sections are determined through maximum and minimum values, and the key points are corrected according to actual data. In addition, the key points may also be corrected according to professional knowledge. For example, a small peak of growth may occur between 16:00 and 18:00 in a service, and then the two points 16:00 and 18:00 may be taken as key points during segmentation.

In an embodiment of the present disclosure, the similarity calculation module is particularly configured to calculate similarity values of historical days and a to-be-predicted day, select similar historical days corresponding to similarity values greater than a preset threshold, and calculate a trend similarity value of similar historical daily data and the data daily reference line within each divided time section respectively.

In the embodiment, the trend similarity value may be calculated through the following formulas:

$${R}_{X Y} = \frac{2 [ E ( X Y ) - E ( X ) E ( Y ) ]}{D ( X ) + D ( Y )} , X = ( {x}_{1} , {x}_{2} , … , {x}_{n} ) , Y = ( {y}_{1} , {y}_{2} , … , {y}_{n} )$$

where, R_{XY} represents the trend similarity value, E(XY) represents an expectation of XY, EV) represents an expectation of X, E(Y) represents an expectation of Y, D(X) represents variance of X, and D(Y) represents variance of Y. X is the data daily reference line, and Y is the historical daily data.

In the embodiment, historical daily data corresponding to a trend similarity value greater than a preset reference value is chosen to form a similarity sequence matrix. The matrix may be:

$${c}_{i j} = [ \begin{matrix}{c}_{11} & {c}_{12} & … & {c}_{1 j} \\ {c}_{21} & {c}_{22} & … & {c}_{2 j} \\ ⋮ & ⋮ & ⋮ & ⋮ \\ {c}_{i 1} & {c}_{i 2} & … & {c}_{i j}\end{matrix} ]$$

where, cᵢⱼ is the j^{th} similarity sequence of the i^{th} section in the divided time sections.

Here, the superiority of the present disclosure is verified by experiment. Thermal load predicted values of 30 days (24 hours a day, corresponding to a thermal load value per hour, and the time section is selected as 2018.06.01-2018.06.30) are selected as experimental data, in which data of 23 days is used as training set data, and data of the last 7 days is used as a test data set. A root mean square error (RMSE) and a mean absolute percentage error (MAPE) are selected as measurement indexes of experimental results.

Three algorithms are compared respectively:

(1) a simple weather similarity algorithm;

(2) a similar subsequence direct connection algorithm; and

(3) the algorithm of the present disclosure.

Description is provided by comparing RMSE and MAPE indexes of the three methods, and data is as follows:

$$RMSE \text{:} RMSE = \sqrt{\frac{1}{n} {\sum }_{i = 1}^{n} {( {y}_{d} ( i ) - {y}_{t} ( i ) )}^{2}}$$

$$MAPE \text{:} MAPE = \frac{1}{n} {\sum }_{i = 1}^{n} \vert ( {y}_{d} ( i ) - {y}_{t} ( i ) ) \text{/} {y}_{t} ( i ) \vert \times 100 \%$$

where: yₜ represents a true value, y_{d} represents a predicted value, and n represents a sample number.

Calculation results are as shown in Table 1 below:

TABLE 1

| | | | Similar |
|---|---|---|---|
| | | Simple | subsequence |
| | Algorithm as | weather | direct |
| Evaluation | provided | similarity | connection |
| index | herein | algorithm | algorithm |
| RMSE | 1.19 | 2.38 | 1.85 |
| MAPE | 3.38% | 6.11% | 4.52% |

Through the comparison of experimental data, it can be seen that the method proposed herein can achieve better effects in thermal load prediction.

Contents such as information exchange and execution process among the modules in the device are based on the same conception as the embodiment of the method of the present disclosure. Specific contents can be obtained with reference to the description in the embodiment of the method of the present disclosure, and are not described in detail here.

It should be noted that, herein, the relation terms such as first and second are merely used to distinguish one entity or operation from another entity or operation, and do not require or imply that the entities or operations have this actual relation or order. Moreover, the terms “include,” “comprise” or other variations thereof are intended to cover non-exclusive inclusion, so that a process, method, item or device including a series of elements not only includes the elements, but also includes other elements not clearly listed, or further includes elements inherent to the process, method, item or device. In the absence of more limitations, an element defined by the statement “including a/an . . . ” does not exclude that the process, method, item or device including the element further has other identical elements.

Those of ordinary skill in the art should understand that all or a part of the steps of the method embodiment can be implemented by a program instructing relevant hardware. The program may be stored in a computer-readable storage medium. When the program is executed, the steps of the method embodiment are performed. The storage medium may be various media that can store program code, such as a ROM, a RANI, a magnetic disk, and an optical disk.

Finally, it should be noted that the above are preferred embodiments of the present disclosure, and are only intended to describe the technical solution of the present disclosure but not to limit the protection scope of the present disclosure. Any modifications, equivalent replacements, improvements and the like made within the spirit and principle of the present disclosure all fall within the protection scope of the present disclosure.

What is claimed is:

1. A method for predicting a thermal load of an electrical system, wherein the method comprises:
S1: pre-processing historical daily data of the thermal load of the electrical system to obtain pre-processed historical daily data;
S2: acquiring a data daily reference line according to the pre-processed historical daily data;
S3: dividing the data daily reference line into a plurality of time sections;
S4: screening the pre-processed historical daily data to obtain screened historical daily data, and calculating a trend similarity value of the screened historical daily data and the data daily reference line within each divided time section of the plurality of time sections respectively;
S5: choosing the screened historical daily data corresponding to the trend similarity value greater than a preset reference value to form a similarity sequence matrix; and
S6: inputting the similarity sequence matrix into a constructed extreme learning machine (ELM) for training, acquiring a prediction model, and predicting the thermal load of the electrical system.

2. The method according to claim 1, wherein a specific process of step S1 comprises:
denoising, filling, and normalizing the historical daily data of the thermal load of the electrical system.

3. The method according to claim 1, wherein a specific process of step S2 comprises:
taking a data mean of a preset number of days closest to a to-be-predicted day as the data daily reference line.

4. The method according to claim 1, wherein a specific process of step S3 comprises:
dividing the data daily reference line into the plurality of time sections according to extreme points in the data daily reference line.

5. The method according to claim 1, wherein a specific process of step S3 comprises:
dividing the data daily reference line into the plurality of time sections according to according to points with a difference between slopes of two adjacent points greater than a preset threshold and extreme points in the data daily reference line.

6. The method according to claim 1, wherein a specific process of step S4 comprises:
calculating similarity values of historical days and a to-be-predicted day, and selecting similar historical days corresponding to the similarity values greater than a preset threshold; and
calculating the trend similarity value of similar historical daily data and the data daily reference line within each divided time section of the plurality of time sections respectively.

7. A device for predicting a thermal load of an electrical system, wherein the device comprises: a data processing module, a baseline determination module, a time segmentation module, a similarity calculation module, a sample screening module, and a training model module, wherein
the data processing module is configured to pre-process historical daily data of the thermal load of the electrical system to obtain pre-processed historical daily data;
the baseline determination module is configured to acquire a data daily reference line according to the pre-processed historical daily data;
the time segmentation module is configured to divide the data daily reference line into a plurality of time sections;
the similarity calculation module is configured to screen the pre-processed historical daily data to obtain screened historical daily data, and calculate a trend similarity value of the screened historical daily data and the data daily reference line within each divided time section of the plurality of time sections respectively;
the sample screening module is configured to choose the screened historical daily data corresponding to the trend similarity value greater than a preset reference value to form a similarity sequence matrix; and
the training model module is configured to input the similarity sequence matrix into a constructed extreme learning machine (ELM) for training, acquire a prediction model, and predict the thermal load of the electrical system.

8. The device for predicting the thermal load of an electrical system according to claim 7, wherein the data processing module is configured to denoise, fill, and normalize the historical daily data of the thermal load of the electrical system;
and/or
the baseline determination module is configured to take a data mean of a preset number of days closest to a to-be-predicted day as the data daily reference line.

9. The device according to claim 7, wherein the time segmentation module is configured to divide the data daily reference line into the plurality of time sections according to extreme points in the data daily reference line;
or
the time segmentation module is configured to divide the data daily reference line into the plurality of time sections according to according to points with a difference between slopes of two adjacent points greater than a preset threshold and the extreme points in the data daily reference line.

10. The device according to claim 7, wherein the similarity calculation module is configured to calculate similarity values of historical days and a to-be-predicted day, select similar historical days corresponding to the similarity values greater than a preset threshold, and calculate the trend similarity value of similar historical daily data and the data daily reference line within each divided time section of the plurality of time sections respectively.
